(19) United States
(12) Patent Application Publication
(10) Pub. No.: US 2016/0311417 A1
(43) Pub. Date: Oct. 27, 2016

(54) Hydraulic Unit

(71) Applicant: ROBERT BOSCH GMBH, Stuttgart (DE)

(72) Inventor: Oliver Gaertner, Abstatt (DE)

(21) Appl. No.: 15/104,266

(22) PCT Filed: Dec. 17, 2014
(86) PCT No.: PCT/EP2014/078319

§ 371 Date: Jun. 14, 2016

(30) Foreign Application Priority Data
Dec. 20, 2013 (DE) 10 2013 226 817.3

(51) Int. Cl. B60T 8/40; B60T 17/02

(52) U.S. Cl. CPC B60T 8/4031; B60T 17/02

(57) ABSTRACT

A hydraulic unit includes a housing block, a pump receptacle formed on the housing block, and a pump element inserted into the pump receptacle. The pump element forms a separating point with the housing block. The separating point hydraulically separates low-pressure and high-pressure regions of the pump element. Known separating points are divided into sections. A first section forms a force closure between the housing block and pump element and a second section forms an axial stop where the pump element mechanically abuts the housing block. Pressure medium, under high pressure, from the high-pressure region can reach the section of the separating point forming the axial stop and cause corrosion. The section of the separating point forming the force closure faces the high-pressure region of the pump element to prevent access of pressurized pressure medium to the section of the separating point forming the axial stop and avoid corrosion.

### STATE OF THE ART

The invention relates to a hydraulic unit, particularly for a vehicle brake system with traction control, according to the generic features of claim 1. Such a hydraulic unit is disclosed by DE 10 2008 003 456 A1, for example.

This known hydraulic unit has a housing block with a pump socket formed on the housing block and a pump element inserted into this pump socket. The pump element together with the housing block forms a hydraulically functioning separator, which separates a low-pressure area of the pump element from a high-pressure area. This separator is subdivided into a portion which forms a non-positive connection between the housing block and the pump element, and a second portion on which the pump element bears axially on the housing block.

In the bearing contact area, a shoulder of a liner for guiding a piston of the pump element bears on a counter-shoulder, which is formed on the inside wall of the pump socket of the housing block. The shoulder and the counter-shoulder are represented by opposing component chamfers. In producing the non-positive connection between the housing block and the pump element, these chamfers act as a geometrical axial stop, which limits the press-fitting forces and the maximum press-fitting depth of the pump element.

In the known hydraulic unit, the portion forming the non-positive connection faces the low-pressure area of the pump element, so that fluid under high pressure from the high-pressure area of the pump element may penetrate to the bearing contact area and to the shoulder of the pump element and to the counter-shoulder of the pump socket.

The liner of the pump element is composed of steel, whilst the housing block is made from an aluminum alloy. Furthermore, owing to their function as a mechanical axial stop, the shoulder and the counter-shoulder are exposed to mechanical stresses when pressing the pump element into the pump socket. These factors added together may mean that in the state of the art cited unwanted corrosion can occur at the stop area of the separator, that is to say between the shoulder and the counter-shoulder and between the housing block and the pump element.

### ADVANTAGES OF THE INVENTION

The invention according to the features of claim 1 on the other hand has the advantage that corrosion is prevented in the stop area of the pump element and the pump socket. This is achieved in that a separator provided between the high-pressure area and the low-pressure area of the pump element comprises a portion forming a non-positive connection, which according to the invention faces the high-pressure area of the pump element. The portion forming the non-positive connection prevents fluid under high pressure being able to penetrate to the stop area of the separator. This serves to prevent the occurrence of a corrosive interaction between the different materials of the housing block and the pump element when large stresses are superimposed on the mechanical axial stop and the fluid under high pressure acts as an electrolyte. In other words, the invention to a large extent isolates the mechanically highly stressed axial stop between the pump element and the housing block from the fluid.

The proposed measure can be implemented without any additional outlay and has no other repercussions either in additional overall space or increased component or assembly costs. Further advantages and advantageous developments of the invention emerge from the dependent claims and/or the following description.

It is especially advantageous if the separator between the high-pressure area and the low-pressure area of the pump element is subdivided into at least three portions, of which two portions each form a non-positive connection between the pump element and the housing block, a third portion acts as axial stop of the pump element on the housing block, and this third portion is arranged between the two portions forming a non-positive connection. This arrangement allows neither fluid from the high-pressure area of the pump element nor fluid from the low-pressure area of the pump element to penetrate to the portion of the separator forming the axial stop. The axial stop or the third portion of the separator is therefore largely free of fluid or dry, thereby serving even more effectively to prevent corrosive effects between the components.

It is particularly easy, in production engineering terms, to effect a non-positive connection between the pump element and the housing block by matching the external dimensions of the pump element to the internal dimensions of the pump socket, in such a way that when fitting the pump element into the pump socket at least some portions thereof are pressed into this pump socket. To monitor the press-fitting operation when assembling, for example with regard to the press-fitting force or the extent to which the pump element is pressed into the pump socket, a shoulder, which interacts with a counter-shoulder on the pump element or on the pump housing, is advantageously provided on the pump housing or on the pump element. Here the shoulder and the counter-shoulder may be formed at right-angles or at an inclined angle to a longitudinal axis of the pump element, the right-angled design advantageously preventing radial movements caused, for example, by differing thermal expansion of the components.

### DRAWING

Exemplary embodiments of the invention are represented in the drawing and explained in more detail in the following description.

FIG. 1 discloses a first exemplary embodiment of the invention, which is represented in the form of a longitudinal section through a pump element inserted into a pump socket of a housing block.

FIG. 2 shows a second exemplary embodiment of the invention in the form of a detailed sketch, which represents a separator between a liner of the pump element and a pump socket of a housing block.

### DESCRIPTION OF THE EXEMPLARY EMBODIMENTS

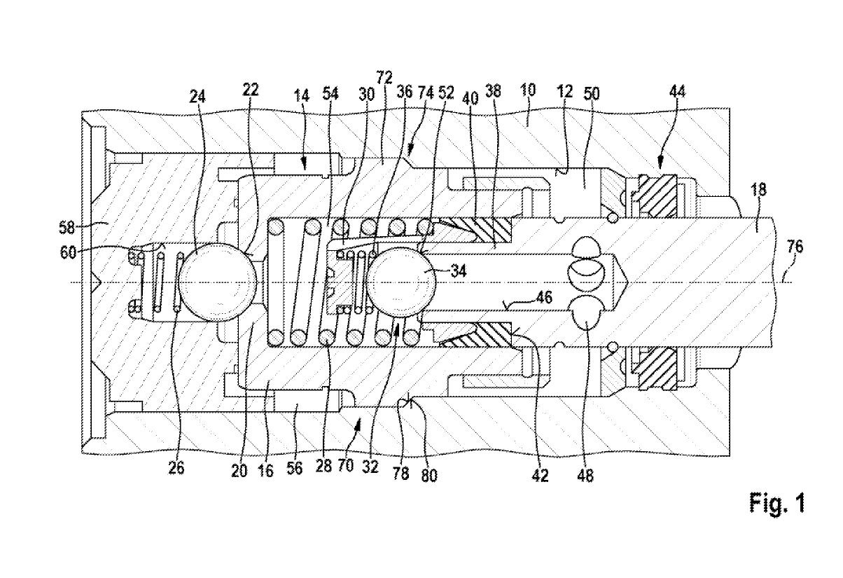

In FIG. 1 a housing block of a hydraulic unit is denoted by the reference numeral 10. This housing block 10 is provided with a pump socket 12, into which a pump element 14 is fitted. The pump socket 12 is a bore, which is open towards one outer side of the housing block 10 and which in its inside diameter is repeatedly stepped or reduced from the outside inwards.

The pump element 14 inserted into the pump socket 12 comprises, among other things, a liner 16, in which a piston 18 of the pump element 14 is received and guided in its reciprocating motion. The liner 16 is of canister-shaped formation and is closed at one of its ends by a liner base 20. Situated in the center of this liner base 20 is a passage, which outside the liner 16 is developed to form a discharge valve seat 22. For controlling this discharge valve seat 22 a discharge valve closing element 24 is provided in the form of a ball, which is pressed against the discharge valve seat by a discharge valve spring 26. In the representation the discharge valve closing element 24 is bearing upon the discharge valve seat 22 and closing the latter.

The opposite end of the liner 16 to the liner base 20 is open and a portion of the piston 18 received inside the liner 16 protrudes from this opening. This is brought about by a return spring 28, which acts upon the piston 18 and which is arranged inside the liner 16, and which is supported on the inside of the liner base 20. With its second end the return spring 28 acts on a valve cage 30 of an inlet valve 32 of the pump element 14. The valve cage 30 is fixed to the liner-side end of the piston 18 and in its interior accommodates an inlet valve closing element 34 and an inlet valve spring 36 for actuating this inlet valve closing element 34. The valve cage 30 encloses an axial extension 38 integrally formed on the piston 18, the outside diameter of which extension is reduced in relation to that of the piston 18. The axial extension 38 accommodates a sealing ring 40, which serves to seal the piston 18 off in the liner 16. This sealing ring 40 is pre-stressed by the return spring 28 of the piston 18, which acts via the valve cage 30 on a first end face of the sealing ring 40. The opposite, second end face of the sealing ring 40 bears on a right-angled shoulder 42 of the piston 18. This shoulder 42 emerges at the end of the axial extension 38 of the piston 18.

The portion of the piston 18 protruding from the liner 16 is guided and sealed off in the pump socket 12 by a sealing/guide ring arrangement 44 arranged on the housing block side.

The piston 18 is provided with a longitudinal bore 46 in the nature of a blind hole, which opens out towards the inside of the liner 16. This longitudinal bore 46 is connected by multiple transverse bores 48, opening out outside the liner 16 and distributed over the circumference of the piston 18, to a low-pressure area 50 of the pump element 14 which surrounds the piston 18 and ultimately leads to a pump inlet (not shown). The open end of the longitudinal bore 46 forms an inlet valve seat 52, the cross section of which is controlled by the inlet valve closing element 34. A pump chamber 54, the volume of which increases or diminishes according to the direction of movement of the piston 18, is situated between the inlet valve seat 52 and the discharge valve seat 22.

A high-pressure area 56 of the pump element 14, into which fluid flowing out of the discharge valve seat 22 flows, is situated downstream of the discharge valve seat 22. The high-pressure area 56 of the pump element 14 is ultimately in contact with a pump outlet, not shown. The high-pressure area 56 of the pump element 14 is sealed off from the surroundings by a plug 58 which is pressed into the end of the pump socket 12 open to the surroundings, and which in addition is externally calked to the housing block 10. The plug 58 forms a housing 60, oriented towards the inside of the pump socket 12, for the discharge valve closing element 24 and the discharge valve closing spring 26.

The pump element 14 together with the pump socket 12 forms a separator 70, which is arranged between the low-pressure area 50 and the high-pressure area 56 of the pump element 14, in order to separate these two areas from one another hydraulically. The separator 70 is subdivided into portions. In a first portion 72 the pump element 14 is connected non-positively to the pump socket 12 and in a second portion 74 directly adjoining the first portion 72 the pump element 14 bears axially on the pump socket 12 of the housing block 10. The second portion 74 therefore forms an axial stop for the pump element 14 in the pump socket 12. According to the invention the first portion 72 forming a non-positive connection faces the high-pressure area 56 of the pump element 14.

In the area of the first portion 72 of the separator 70 forming the non-positive connection the inside diameter of the pump socket 12 is reduced. A transition from the larger to the smaller inside diameter of the pump socket 12 is designed as an annular chamfer, in order to facilitate the assembly of the pump element 14. The liner 16 of the pump element 14 has an enlarged outside diameter in the first portion 72 of the separator 70.

Here the outside diameter of the liner 16 is matched to the inside diameter of the pump socket 12, in such a way that when the pump element 14 is fitted into the pump socket 12 a press-fit connection, which runs around the circumference of the pump element 14, occurs between the two parts.

In the direction of a longitudinal axis 76 of the pump element 14 the second portion 74 of the separator 70 directly adjoins the first portion 72 described above. It is formed by an annular shoulder 78, which is constituted on the inner circumference of the pump socket 12 or on the outer circumference of the liner 16, and a correspondingly formed counter-shoulder 80, which is formed running around the outer circumference of the liner 16 or on the inner circumference of the pump socket 12. In this exemplary embodiment the shoulder 78 and the counter-shoulder 80 form component chamfers, which form an angle of between 30° and 60°, preferably an angle of 45°, with the longitudinal axis 76 of the pump element 14.

The second portion 74 of the separator 70 constitutes a mechanical stop when pressing the pump element 14 into the pump socket 12. According to the invention it is situated remotely from the high-pressure area 56 of the pump element 14 and due to the first portion 72 of the separator 70, inventively facing the high-pressure area 56 of the pump element 14 and forming a non-positive connection, it does not come into contact with fluid under high pressure.

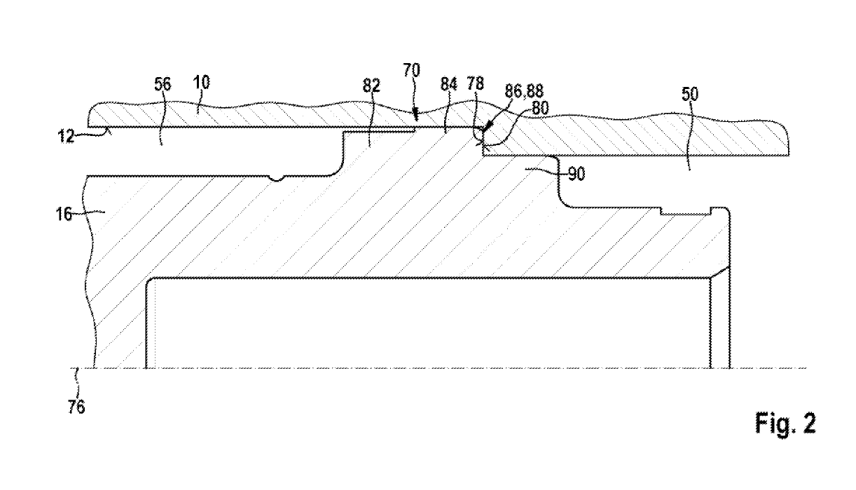

FIG. 2 shows a second exemplary embodiment of the invention. A portion of a liner 16, which is inserted into a pump socket 12, can be seen. The liner 16 together with the pump socket 12 forms a separator 70, likewise comprising multiple portions or zones, between the high-pressure area 56 and the low-pressure area 50 of a pump element 14, not represented in detail. Viewed from the high-pressure area 56 of the pump element 14 in the direction of the longitudinal axis 76 of this pump element 14, there are a total of four portions. In portion one 82 the liner 16 of the pump element 14 forms a controlled-gap seal with the pump socket 12 of the housing block 10. This is achieved by an outside diameter of the liner 16, which in this zone (portion one) is only slightly smaller than the associated inside diameter of the pump socket 12. In a following portion two 84 a non-positive connection or press-fit connection exists between the liner 16 and the pump socket 12. For this purpose, the outside diameter of the liner 16 is designed slightly larger than the associated inside diameter of the pump socket 12. In a portion three 86 the pump element bears on an axial stop 88. For this purpose, the pump socket 12 forms a shoulder 78, against which a counter-shoulder 80 of the liner 16 bears. The shoulder 78 and the counter-shoulder 80 form plane faces which, viewed in the drawing plane, run enclosing a right-angle (90°) with a longitudinal axis of the pump element 14 or the liner 16 of the pump element 14. The pump element 14 strikes against this axial stop 88 with its liner 16 when the latter has been inserted into the pump socket 12 to a fixed press-fit depth. An axially adjoining portion four 90 beyond this again forms a non-positive connection between the liner 16 and the pump socket 12, in that the diameter of the liner 16 is of slightly larger dimension than the corresponding inside diameter of the pump socket 12. The diameters in the two portions two and four 84, 90 forming a non-positive connection are of different dimensions, the diameter in portion two 84 being designed larger than the diameter in portion four 90. The variation in diameter between the portions two and four 84, 90 in this exemplary embodiment forms the right-angled shoulder 78, against which the counter-shoulder 80 of the liner 16 of correspondingly right-angled formation strikes as soon as the latter has reached its intended press-fit depth.

In this second exemplary embodiment the two portions two and four 84, 90 each forming a non-positive connection between the pump element 14 and the pump socket 12, prevent fluid from the high-pressure area 56 or fluid from the low-pressure area 50 of the pump element 14 reaching portion three 86 of the separator 70 forming the axial stop 88 between the pump element 14 and the pump socket 12. Consequently, they seal off portion three 86 against the ingress of fluid and thereby prevent corrosion between the shoulder 78 and the counter-shoulder 80 on the pump element 14 and/or on the pump socket 12.

Modifications or advantageous developments to the exemplary embodiments described are obviously feasible, without departing from the basic idea of the invention.

1. A hydraulic unit, comprising:
a housing block;
a pump socket formed in the housing block; and
a pump element inserted into the pump socket,
wherein the pump element and the housing block form a separator configured to hydraulically separate a low-pressure area of the pump element in contact with a pump inlet from a high-pressure area of the pump element in contact with a pump outlet,
wherein the separator includes a first portion, on which the pump element is connected to the housing block by a non-positive connection, and a second portion, on which the pump element forms an axial stop with the housing block, and
wherein the first portion of the separator lies facing the high-pressure area of the pump element.

2. The hydraulic unit as claimed in claim 1, wherein:
the separator includes a third portion, on which the pump element is connected by a non-positive connection to the housing block,
the third portion of the separator lies facing the low-pressure area of the pump element, and
the second portion of the separator is arranged between the first and third portions of the separator.

3. The hydraulic unit as claimed in claim 1, wherein the first portion and the second portion of the separator directly adjoin one another in the direction of a longitudinal axis of the pump element.

4. The hydraulic unit as claimed in claim 1, wherein the non-positive connection between the pump element and the pump socket on the housing block is a press-fit connection.

5. The hydraulic unit as claimed in claim 4, wherein the second portion of the separator includes a shoulder, formed on one of the housing block and the pump element, and a counter-shoulder formed on the other of the pump element and the housing block.

6. The hydraulic unit as claimed in claim 5, wherein the shoulder and the counter-shoulder enclose an angle of 90° with the longitudinal axis of the pump element.

7. The hydraulic unit as claimed in claim 1, wherein:
the pump element has a liner configured to guide a piston of the pump element, and
the liner, together with an inside wall of the pump socket of the housing block, forms the separator.

8. The hydraulic unit as claimed in claim 1, wherein:
the pump socket on the housing block is formed by a bore,
the bore is open to outside the housing block at one end and is stepped in its inside diameter,
the open end of the pump socket is closed by a plug, and
the pump element is supported on the plug.

9. The hydraulic unit as claimed in claim 5, wherein the shoulder and the counter-shoulder enclose an angle of between 30° and 60° with the longitudinal axis of the pump element.

10. The hydraulic unit as claimed in claim 9, wherein the angle is approximately 45°.
